(19) United States
(12) Patent Application Publication
(10) Pub. No.: US 2013/0230336 A1
(43) Pub. Date: Sep. 5, 2013

(54) ROLL MEMBER, CHARGING DEVICE, IMAGE FORMING APPARATUS, AND PROCESS CARTRIDGE

(71) Applicant: FUJI XEROX CO., LTD., Tokyo (JP)

(72) Inventor: Shogo TOMARI, Kanagawa (JP)

(73) Assignee: FUJI XEROX CO., LTD., Tokyo (JP)

(21) Appl. No.: 13/633,501

(22) Filed: Oct. 2, 2012

(30) Foreign Application Priority Data
Mar. 5, 2012 (JP) 2012-048266

(51) Int. Cl. G03G 15/02; G03G 21/18

(52) U.S. Cl. 399/111; 399/176

(57) ABSTRACT

A roll member includes a core; and an elastic layer which contains a rubber composition having a thiourethane bond represented by Formula (1) on the core:

—(S—C(═O)—N(—H))—. Formula (1)

### CROSS-REFERENCE TO RELATED APPLICATIONS

This application is based on and claims priority under 35 OSC 119 from Japanese Patent Application No. 2012-048266 filed Mar. 5, 2012.

### BACKGROUND

1. Technical Field

The present invention relates to a roll member, a charging device, an image forming apparatus, and a process cartridge.

2. Related Art

In electrophotographic image forming apparatuses, as a charging member which charges a photoreceptor, a member equipped with a conductive roller in which an elastic layer formed of a rubber composition is formed on a core, is being used.

### SUMMARY

According to a first aspect of the invention, there is provided a roll member including a core; and an elastic layer which contains a rubber composition having a thiourethane bond represented by Formula (1) on the core:

—(S—C(═O)—N(—H))—. Formula (1)

### BRIEF DESCRIPTION OF THE DRAWINGS

Exemplary embodiments of the present invention will be described in detail based on the following figures, wherein:

FIG. 1 is a diagram schematically illustrating an example of an image forming apparatus according to an exemplary embodiment of the invention; and

FIG. 2 is a diagram schematically illustrating an example of a process cartridge according to an exemplary embodiment of the invention.

### DETAILED DESCRIPTION

Hereinafter, exemplary embodiments of the invention will be described.

### Roll Member

A roll member according to an exemplary embodiment of the invention includes a core; and an elastic layer which contains a rubber composition having a thiourethane bond represented by Formula (1) on the core:

—(S—C(═O)—N(—H))—. Formula (1)

In the related art, in roll members which include an elastic layer formed of a rubber composition, such as charging rollers used for an image forming apparatus, there is a case where a surface of the rubber composition is degraded and melted by ozone, which may lead to contamination of a contact portion (for example, a photoreceptor) being in contact with the surface. When a photoreceptor is contaminated, there may be unevenness in image density in a formed image.

In addition, in a high-temperature environment, high-humidity environment, or the like, when a rubber composition is melted or hydrolyzed, a melted or degraded material contaminates a contact portion such as a photoreceptor as in a case where a rubber composition is melted by ozone. This may leads to unevenness in image density and furthermore image defects due to the change of size or hardness caused by deformation.

On the other hand, in the roll member according to the exemplary embodiment, since the elastic layer contains the rubber composition having the thiourethane bond as described above, ozone resistance is superior and the melting of the rubber composition which is caused by ozone is suppressed. In addition, resistance to heat and humidity is superior and the melting and degrading of the rubber composition are suppressed in a high-temperature environment or in a high-humidity environment.

As a result, for example, even when the roll member according to the exemplary embodiment, is used as a roll member (for example, a charging member) being in contact with a photoreceptor of an image forming apparatus, unevenness in image density is suppressed.

Hereinafter, configurations of the respective layers of the roll member according to the exemplary embodiment will be described in detail.

### Core

The core is a cylindrical member which functions as an electrode and a support member of the roll member, and examples of the material thereof include metals such as iron (for example, free-cutting steel), copper, brass, stainless steel, aluminum, and nickel. In addition, examples of the core include members of which an outside surface is plated (for example, a resin or a ceramic member); and members with a conductive material dispersed (for example, a resin or a ceramic member). The core may be a hollow member (tubular member) or a non-hollow member.

### Elastic Layer

The elastic layer contains a rubber composition having a thiourethane bond represented by Formula (1) below:

—(S—C(═O)—N(—H))—. Formula (1)

In addition, the thiourethane bond is formed as follows by synthesis of a compound having a thiol group (—SH) and a compound having an isocyanate group (—N═C═O).

R—SH+O═C═N—R′→R—S—C(═O)—N(—H)—R′

### Compound Having Thiol Group

The compound having a thiol group is not particularly limited, but a polysulfide polymer is preferably used.

### Polysulfide Polymer

The polysulfide polymer according to the exemplary embodiment is a polymer having a sulfide bond “—Sₓ—” in which x represents preferably an integer of from 1 to 0.5, more preferably an integer of from 1 to 4, still more preferably an integer of from 1 to 3, even still more preferably 1 or 2, and most preferably 2.

In addition, it is preferable that the polysulfide polymer is a polysulfide polymer (A), and the polysulfide polymer (A) contains a structural unit of “—S—” and at least one structural unit selected from “—(C₂H₄OCH₂OC₂H₄)—” and “—(CH₂CH(OH)CH₂)—” and has a thiol group (—SH) in a terminal thereof.

Among the polysulfide polymers (A), a polysulfide polymer having a structural unit represented by “—(CH₂CH(OH)CH₂)—” is preferable. When an OH group is included, it is considered that the OH group forms a urethane bond with the compound having isocyanate groups (—N═C═O) described below, and the polysulfide polymer having a structural unit represented by “—(CH₂CH(OH)CH₂)—” is more preferable from the viewpoints of easy kneading with the compound having isocyanate groups and easy reactivity.

In addition, among the polysulfide polymers (A), a polysulfide polymer having a structural unit represented by “—(C₂H₄OCH₂OC₂H₄)—” is more preferable from the viewpoint of superior heat resistance.

In addition, it is more preferable that the thiol group which is present in a terminal be at least one of thiol groups represented by “—C₂H₄OCH₂OC₂H₄—SH” and “—CH₂CH(OH)CH₂—SH”.

The concentration of the thiol group (—SH) in the poly sulfide polymer (the concentration in terms of % by weight with respect to 100 parts by weight of the polysulfide polymer) is preferably from 1.0% by weight to 6.0% by weight and more preferably from 1.5% by weight to 2.5% by weight.

Furthermore, it is preferable that, the polysulfide polymer have a polyether unit represented by —(R¹O)ₙ— (wherein, R¹ represents an alkylene group having from 2 to 4 carbon atoms and n represents an integer of from 6 to 200). When this polyether unit is included, the surface hardness is reduced and the roll member comes into contact along a surface of a contact member. Accordingly, when the roll member is used as a charging member, charging performance for a charged member is improved.

In the polyether unit, R¹ represents an alkylene group having from 2 to 4 carbon atoms which may be linear or branched and preferably linear.

In the polyether unit, n represents an integer of from 6 to 200, preferably an integer of from 50 to 150, and more preferably from 80 to 120.

The number average molecular weight of the polysulfide polymer is preferably from 500 to 10,000, more preferably from 1,000 to 8,000, and still more preferably from 2,500 to 5,000.

The number average molecular weight is obtained through measurement, using gel permeation chromatography (GPC) and a THF solvent and calculation using a molecular weight calibration curve prepared from monodispersed polystyrene standard samples.

As the polysulfide polymer according to the exemplary embodiment, commercially available products may be used, and examples thereof include THIOCOL LP-2, LP-23, LP-3, and LP-282 (all of which are manufactured by Toray Fine Chemicals Co. Ltd.).

### Compound Having Isocyanate Group

As the compound having isocyanate groups (—N═C═O), a compound (B) having at least two or more isocyanate groups is preferably used.

Examples of the compound having isocyanate groups include aromatic polyisocyanate and aliphatic polyisocyanate.

The aromatic polyisocyanate is an organic polyisocyanate having two or more isocyanate groups. Examples of the aromatic polyisocyanate include tolylene diisocyanate (2,4-TDI or 2,6-TDI), 4,4′-diphenylmethane diisocyanate (4,4′-MDI), 2,4′-diphenylmethane diisocyanate (2,4′-MDI), polymethylene polyphenyl polyisocyanate (polymeric MDI), xylene diisocyanate (2,4-XDI or 2,6-XDI), 1,5-naphthylene diisocyanate (MDI), TDI trimer, and XDI trimer.

Examples of the aliphatic polyisocyanate include tetramethylene diisocyanate, 1,5-pentamethylene diisocyanate, 1,6-hexamethylene diisocyanate (hereinafter, abbreviated as “HDI”), 2,2,4 (or 2,4,4)-trimethyl-1,6-hexamethylene diisocyanate, lysine isocyanate, isophorone diisocyanate, hydrogenated xylene diisocyanate, hydrogenated diphenylmethane diisocyanate, 1,4-diisocyanate cyclohexane, 1,3-bis(diisocyanate methyl)cyclohexane, 4,4′-dicyclohexylmethane diisocyanate, HDI trimer, IPDI trimer, and modified polyisocyanate obtained by modifying the above examples.

Examples of a modified product thereof include urethane-modified products which are reactants with an active hydrogen compound, carbodiimide-modified products, isocyanurate-modified products, burette-modified products, and allophanate-modified products, and these organic polyisocyanates may be used alone or as a mixture thereof.

Among these examples, for example, tolylene diisocyanate (2,4-TDI or 2,6-TDI), xylene diisocyanate (2,4-XDI or 2,6-XDI), TDI trimer, XDI trimer, 4,4′-diphenylmethane diisocyanate (4,4′-MDI), 2,4′-diphenylmethane diisocyanate (2,4′-MDI), polymethylene polyphenyl polyisocyanate (polymeric MDI), aliphatic isocyanurate polyisocyanate, HDI trimer, and IPDI trimer are preferable. Among these examples, 4,4′-diphenylmethane diisocyanate (4,4′-MDI), xylene diisocyanate (2,4-XDI or 2,6-XDI), HDI trimer, and IPDI trimer are more preferable.

### Synthesis of Polysulfide Polymer and Compound Having Isocyanate Groups

The rubber composition having the thiourethane bond represented by Formula (1) is synthesized from the polysulfide polymer and the compound having isocyanate groups according to a method in which the polysulfide polymer and the compound (urethane prepolymer) having an isocyanate group are mixed with a catalyst and heated (for example, at 110° C. for 30 minutes and at 100° C. for 8 hours), for example, as described below in (Example 1) or (Example 2).

˜C₂H₄OCH₂OC₂H₄—SH(terminal of polysulfide polymer)+O═C═N˜(OCH(—CH₃)CH₂)ₙO˜(terminal of urethane prepolymer)→˜C₂H₄OCH₂OC₂H₄—S—C(═O)—N(—H)˜ (Example 1)

˜CH₂CH(OH)CH₂—SH(terminal of polysulfide polymer)+O═C═N˜(OCH(—CH₃)CH₂)ₙO˜(terminal of urethane prepolymer)→˜CH₂CH(OH)CH₂—S—C(═O)—N(—H)˜ (Example 2)

Examples of the catalyst used for the synthesis include tin catalysts such as trimethyl tin laurate, dibutyl tin dilaurate, and tin octylate; amine catalysts such as triethylenediamine, 1,8-diazabicycloundec-7-ene (DBU), and 1,4-diazabicyclo[2,2,2]octane (DABCO).

It is preferable that the amount of the catalyst added, be in a range of 0.05 part by weight, to 0.5 part by weight with respect to 100 parts by weight of the polysulfide polymer.

When other additives described below are added to the elastic layer, other additives described below may be added and kneaded for the above-described synthesis before the rubber composition having a thiourethane bond is synthesized or other additives described below may be added to the rubber composition having a thiourethane bond after the synthesis.

The amount of the compound having isocyanate groups mixed with respect, to 100 parts by weight of the compound having a thiol group such as the polysulfide polymer is not particularly limited, but the molar ratio (NCO/SH) of the isocyanate group included in the compound having isocyanate groups and the thiol group included in the polysulfide polymer is preferably in a range of 0.50 to 2.0, more preferably in a range of 0.9 to 1.5, and still more preferably in a range of 1.0 to 1.3. When NCO/SH is in a range of 0.5 to 2.0, a sufficient thiourethane bond may be obtained and thus satisfactory ozone resistance may be obtained.

### Other Additives

For example, the elastic layer may contain additives described below, in addition to the rubber composition having a thiourethane bond. In particular, when the roll member is used as a member for forming an electric field in a charging device or a transfer device of an electrophotographic image forming apparatus, a conductive material is added to the elastic layer.

As this conductive material, for example, a well-known conductive material or organic ion conductive material is used. The conductivity described herein represents a volume resistivity being less than or equal to 10⁴ Ωcm.

Examples of the conductive material include quaternary ammonium salts (for example, perchlorates, chlorates, fluoroborates, sulfates, ethosulfate, and benzyl halides (for example, benzyl bromides and benzyl chlorides) of lauryl trimethyl ammonium, stearyl trimethyl ammonium, octadodecyl trimethyl ammonium, dodecyl trimethyl ammonium, hexadecyl trimethyl ammonium, modified fatty acid dimethyl ethyl ammonium, and the like); aliphatic sulfonates; higher alcohol sulfates; higher alcohol ethylene oxide added sulfates; higher alcohol phosphates; higher alcohol ethylene oxide added phosphates; various betaines; higher alcohol ethylene oxides; polyethylene glycol fatty acid esters; and polyol fatty acid esters.

Examples of the organic ion conductive material include complexes of polyols (for example, 1,4-butanediol, ethylene glycol, polyethylene glycol, and propylene glycol) and derivatives thereof and metal salts; and complexes of monools (for example, ethylene glycol monomethyl ether and ethylene glycol monoethyl ether) and metal salts. Examples of the metal salts include metal salts in the Group 1 of the periodic table such as LiClO₄, LiCF₃SO₃, LiAsF₆, LiBF₄, NaClO₄, NaSCN, KSCN, and NaCl; electrolytes such as salts of NH₄⁺; metal salts in the Group 2 of the periodic table such as Ca (ClO₄)₂ and Ba (ClO₄)₂; and derivatives of these metal salts having at least one active hydrogen-containing group reactive with isocyanate (for example, a hydroxyl group, a carboxyl group, or a primary or secondary amino group). A specific example of the complexes includes a complex of PEL (LiClO₄) and polyethylene glycol. As the conductive material, the above examples may be used alone or in a combination of two or more kinds.

The amount of the conductive material added is not particularly limited. In the case of the conductive material, the amount is preferably in a range of 1 part by weight to 30 parts by weight and more preferably in a range of 15 parts by weight to 25 parts by weight, with respect to 100 parts by weight of the rubber composition having a thiourethane bond. On the other hand, in the case of the organic ion conductive material, the amount is preferably in a range of 0.1 part by weight to 5.0 parts by weight and more preferably in a range of 0.5 part, by weight to 3.0 parts by weight, with respect to 100 parts by weight of the rubber composition having a thiourethane bond.

In addition, examples of the additives include materials which are usually added to the elastic layer, such as an antioxidant, a chain extender, a surfactant, a coupling agent, and a filler (for example, silica or calcium carbonate).

In the exemplary embodiment, since the polysulfide polymer is used, workability and moldability are superior. Therefore, the elastic layer may be formed without, adding a softener and a plasticizer. From the viewpoint of suppressing bleeding, it is preferable that a softener and a plasticizer be not added.

Specific examples of the filler include calcium carbonate, carbon black, and silica. These inorganic fillers may be used alone or in combination of two or more kinds.

The amount of the filler added with respect to the rubber composition is not particularly limited, and is preferably from 1 part by weight to 80 parts by weight and more preferably from 10 parts by weight to 50 parts by weight, with respect to 100 parts by weight of the rubber composition.

### Properties of Elastic Layer

The thickness of the elastic layer varies depending on apparatuses to which the roll member is applied and, for example, is preferably from 1 mm to 10 mm and more preferably from 2 mm to 5 mm.

In addition, the volume resistivity of the elastic layer varies depending on apparatuses to which the roll member is applied. In a case where the roll member is applied to a charging device of an electrophotographic image forming apparatus described below, the volume resistivity is, for example, preferably from 10⁴ Ωcm to 10¹⁰ Ωcm and more preferably from 10⁵ Ωcm to 10⁹ Ωcm.

The volume resistivity is obtained in a method in which a current, value of a sheet-like measurement sample is measured using a measuring instrument (R12702A/B resistivity chamber, manufactured by ADVARTEST CORPORATION) and a high-resistance measuring instrument (R8340A, Digital ultra-high resistance/micro current meter, manufactured by ADVANTEST CORPORATION) 30 seconds after the application of a voltage obtained by adjusting the electric field (applied voltage/thickness of composition sheet) to 1000 V/cm; and using the current value, the following Expression (2) is calculated.

Volume Resistivity (Ω·cm)=(19.63×Applied Voltage (V))/(Current Value (A)×Thickness of Sheet-like Measurement Sample (cm)). Expression (2)

In addition, the hardness of the elastic layer varies depending on apparatuses to which the roll member is applied. In the case where the roll member is applied to a charging device of an electrophotographic image forming apparatus described below, the hardness is, for example, from 15° to 90° or from 15° to 70° in terms of Asker C hardness.

The Asker C hardness is measured under a condition of a load of 1000 g by bringing a measurement needle of an Asker C type durometer (manufactured by KOBUNSHI KEIKI CO., LTD.) into contact with a surface of a 3 mm-thick measurement sheet.

### Surface Layer

In the roll member according to the exemplary embodiment, a surface layer may be formed on the elastic layer.

For example, the surface layer may include a resin and may further include a conductive material, particles for providing convex and concave portions (specific surface roughness) on a surface of the surface layer, and other additives.

Examples of the resin include acrylic resins, cellulosic resins, polyamide resins, nylon copolymer, polyurethane resins, polycarbonate resins, polyester resins, polyethylene resins, polyvinyl resins, polyarylate resins, styrene-butadiene resins, melamine resins, epoxy resins, urethane resins, silicone resins, fluororesins (for example, tetrafluoroethylene-perfluoroalkyl vinyl ether copolymer, tetrafluoroethylene-hexafluoropropylene copolymer, and polyvinylidene fluoride), and urea resins. The nylon copolymer described herein contains one or plural kinds selected from nylon 610, nylon 11, and nylon 12 as a polymerization unit. Examples of another polymerization unit, included in this copolymer include nylon 6 and nylon 66.

As the conductive material mixed into the surface layer, for example, an electron conductive material or an ion conductive material may be used. Examples of the electron conductive material include powders of, for example, carbon blacks such as ketjen black and acetylene black; pyrolytic carbon and graphite; various conductive metals such as aluminum, copper, nickel, and stainless steel or alloys thereof; various conductive metal oxides such as tin oxide, indium oxide, titanium oxide, tin oxide-antimony oxide solid solution, and tin oxide-indium oxide solid solution; and insulating materials of which the surfaces are treated to be conductive. In addition, examples of the ion conductive material include perchlorates and chlorates of tetraethylammonium, lauryl trimethyl ammonium, and the like; perchlorates and chlorates of alkali metals such as lithium and magnesium and alkali earth metals. As the conductive material, the above examples may be used alone or in a combination of two or more kinds.

Specific examples of commercially available product of the carbon black include “SPECIAL BLACK 350”, “SPECIAL BLACK 100”, “SPECIAL BLACK 250”, “SPECIAL BLACK 5”, “SPECIAL BLACK 4”, “SPECIAL BLACK 4A”, “SPECIAL BLACK 550”, “SPECIAL BLACK 6”, “COLOR BLACK FW200”, “COLOR BLACK FW2”, and “COLOR BLACK FW2V” (all of which are manufactured by Evonik Degussa Japan Co., Ltd.); and “MONARCH 1000”, “MONARCH 1300”, “MONARCH 1400”, “MOGUL-L”, and “REGAL 400R” (all of which are manufactured by Cabot Corporation).

In addition, as the particles for providing convex and concave portions on a surface of the surface layer, any one of conductive and nonconductive particles may be used, but nonconductive particles are preferable. Examples of the conductive particles include particles of the materials described above as the examples of the conductive material mixed into the elastic layer. Examples of the nonconductive particles include resin particles (for example, polyimide resin particles, methacrylic resin particles, polystyrene resin particles, fluororesin particles, and silicone resin particles), inorganic particles (for example, clay particles, kaolin particles, talc particles, silica particles, and alumina particles), and ceramic particles. The particles may be particles of the same kind of resin as the above resin. The conductivity described herein represents a volume resistivity being less than 10¹³ Ωcm, and the nonconductivity described herein represents a volume resistivity being greater than or equal to 10¹³ Ωcm. Hereinafter, the same shall be applied.

In addition, examples of other additives used for the surface layer include materials which may be usually added to the surface layer, such as a curing agent, a vulcanizing agent, a vulcanizing accelerator, an antioxidant, a surfactant, and a coupling agent.

It is preferable that, the thickness of the surface layer be from 7 μm to 25 μm. It is preferable that the volume resistivity of the surface layer be from 10³ Ωcm to 10¹⁴ Ωcm.

For the formation of the surface layer, the resin, the conductive material, and the like are dispersed in a solvent to prepare a coating solution, and this coating solution is applied onto the elastic layer which is prepared in advance. Examples of an application method of the coating solution include a blade coating method, a wire-bar coating method, a spray coating method, a dip coating method, a bead coating method, an air knife coating method, and a curtain coating method.

The solvent used for the coating solution is not particularly limited and a common solvent is used, and examples thereof include alcohols such as methanol, ethanol, propanol, and butanol; ketones such as acetone and methyl ethyl ketone; tetrahydrofuran; and ethers such as diethyl ether and dioxane.

### Usage

The roll member with the above-described configurations may be used as, for example, a roll member of a charging device or a transfer device in an electrophotographic image forming apparatus.

### Image Forming Apparatus and Process Cartridge

Hereinafter, a case where the roll member according to the exemplary embodiment is mounted to a charging device of an image forming apparatus and a process cartridge, will be described.

The charging device according to the exemplary embodiment includes the roil member according to the exemplary embodiment.

The image forming apparatus according to the exemplary embodiment includes an image holding member; a charging device that, charges a surface of the image holding member; a latent image forming device that, forms an electrostatic latent image on a charged surface of the image holding member; a developing device that develops the electrostatic latent image, formed on the image holding member, using toner to form a toner image; and a transfer device that, transfers the toner image, formed on the image holding member, onto a recording medium, wherein the charging device is the charging device according to the exemplary embodiment.

The process cartridge according to the exemplary embodiment includes a charging device that charges an image holding member; and at least one kind selected from the image holding member, a developing device that develops an electrostatic latent image on the image holding member, using toner to form a toner image, and a cleaning device that cleans and removes toner remaining on a surface of the image holding member after the toner image is transferred onto a recording medium, wherein the charging device is the charging device according to the exemplary embodiment.

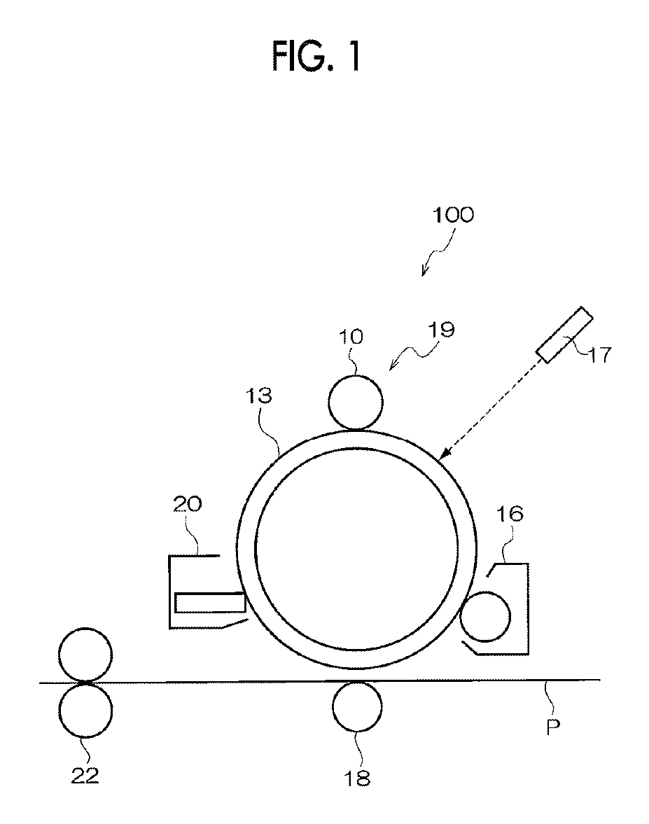

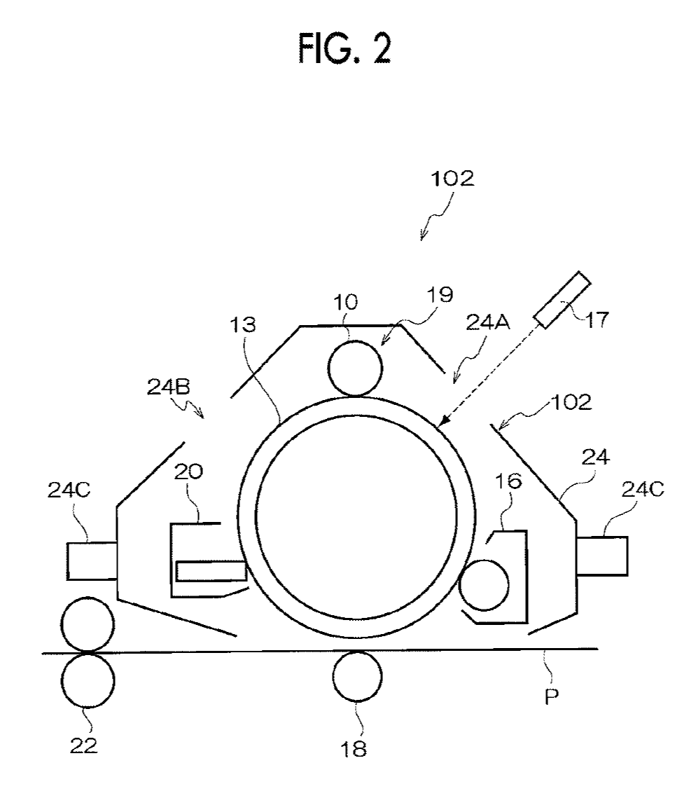

FIG. 1 is a diagram schematically illustrating a configuration of an image forming apparatus according to an exemplary embodiment of the invention. FIG. 2 is a diagram, schematically illustrating a configuration of a process cartridge according to an exemplary embodiment of the invention.

As illustrated in FIG. 1, an image forming apparatus 100 according to the exemplary embodiment, includes an image holding member 13 and further includes, in the vicinity of the image holding member 13, a charging device 19 that, charges the image holding member 13; a latent, image forming device 17 that, forms an electrostatic latent image by exposing the image holding member 13, which is charged by the charging device 19, to light; a developing device 16 that, develops the electrostatic: latent image, which is formed by the latent image forming device 17, using toner to form a toner image; a transfer device 18 that, transfers the toner image, which is formed by the developing device 16, onto a recording medium P; and a cleaning device 20 that cleans and removes toner remaining on the surface of the image holding member 13 after the toner image is transferred. In addition, a fixing device 22 that fixes the toner image which is transferred onto the recording medium P by the transfer device 18 is provided.

In the image forming apparatus 100 according to the exemplary embodiment, the charging device 19 includes a roll member 10 according to the exemplary embodiment. This roll member 10 is arranged in contact with the surface of the image holding member 13 and charges the image holding member 13 with electric power supplied from a power supply device (not illustrated).

In the image forming apparatus 100 according to the exemplary embodiment, to configurations other than that, of the roll member 10 provided in the charging device 19, well-known configurations as the respective configurations of an electrophotographic image forming apparatus of the related art are applied. Hereinafter, examples of the respective configurations will be described.

The image holding member 13 is not particularly limited and a well-known photoreceptor is used. An organic photoreceptor having a so-called functional separation structure in which a charge generation layer and a charge transport layer are separated is preferably used. In addition, in the image holding member 13, it is preferable that the surface layer thereof be coated with a protective layer having a charge transport property and a cross-linked structure. It is also preferable that the photoreceptor contain siloxane resin, phenol resin, melamine resin, guanamine resin, and acrylic resin as cross-linking components of the protective layer.

As the latent image forming device 17, for example, a laser optical system or an LED array may be used.

In the developing device 16, for example, a developer holding member, on which a developer layer is formed, is caused to come into contact with or approach the image holding member 13; and toner is attached onto an electrostatic latent image on the surface of the image holding member 13 to form a toner image. As a development, method of the developing device 16, a development method using a two-component developer as a well-known method is preferably used. Examples of the development method using the two-component developer include cascade development and magnetic brush development.

In the transfer device 18, for example, any one of a non-contact, transfer method using a corotron or the like; and a contact, transfer method in which a conductive transfer roller is brought into contact with the image holding member 13 through the recording medium P to transfer a toner image onto the recording medium P may be used.

The cleaning device 20 is a member that, cleans toner, paper dust, dirt, and the like which are attached onto the surface by, for example, directly bringing a plate-like member into contact with the surface of the image holding member 13. As the cleaning device 20, a brush-like member, a roll-like member, or the like may be used in addition to the plate-like member.

As the fixing device 22, for example, a heat fixing device may be used. For example, the heat fixing device includes a heater lamp for heating in a cylindrical core and further includes a fixing roller in which, a so-called release layer is formed on the outer peripheral side thereof from a heat-resistant resin coating layer or a heat-resistant rubber coating layer; a pressure roller or a pressure belt, which is arranged in contact with the fixing roller at a specific contact pressure and has a heat-resistant elastic layer formed on the outer peripheral side of the cylindrical core or on the surface of a belt-like substrate. Processes of fixing an unfixed toner image are performed by, for example, causing the recording medium P, onto which the unfixed toner image is transferred, to pass through a gap between the fixing roller and the pressure roller or the pressure belt for thermal coalescence of a binder resin, additives, and the like in toner.

The image forming apparatus 100 according to the exemplary embodiment is not particularly limited to the above-described configurations and may be, for example, an intermediate transfer type image forming apparatus using an intermediate transfer member or a so-called tandem type image forming apparatus in which image forming units for forming toner images of the respective colors are arranged in parallel.

In the image forming apparatus 100 illustrated in FIG. 1, a process cartridge according to the exemplary embodiment, is a process cartridge 102 in which, as illustrated in FIG. 2, the image holding member 13; the charging device 19 that charges the image holding member 13 and has the roll member; the developing device 16 that forms a toner image by developing the electrostatic latent image, which is formed by the latent image forming device 17, using toner; and the cleaning device 20 that cleans and removes toner remaining on the surface of the image holding member 13 after the toner image is transferred are integrally combined and held in a case 24 that includes an opening 24A for exposure, an opening 24B for erasing charges and exposure, and an attachment rail 24C. The process cartridge 102 is detachably mounted to the image forming apparatus 100 illustrated in FIG. 1.

The process cartridge according to the exemplary embodiment is not particularly limited as long as it includes the charging device 19 having the roll member according to the exemplary embodiment. For example, in addition to the charging device 19, the process cartridge according to the exemplary embodiment further includes at least, one kind selected from the image holding member 13, the developing device 16, and the cleaning device 20 and is detachable from the image forming apparatus 100. In addition, as illustrated in FIG. 2, the developing device 16 and the cleaning device 20 may be integrally combined.

### EXAMPLES

Hereinafter, the exemplary embodiment will be described with reference to Examples but is not limited to the following Examples.

### Example 1

| | | |
|---|---|---|
| (1) Polysulfide polymer | 100 | parts by weight |
| (trade name: THIOCOL LP-2, concentration | | |
| of SH group: 2.0%, manufactured by | | |
| Toray Fine Chemicals Co. Ltd.) | | |
| (2) Ion conductive material | 0.5 | part by weight |
| (trade name: BTMAC-100, benzyl | | |
| trimethyl ammonium chloride, | | |
| manufactured by Lion Akzo Co., Ltd.) | | |
| (3) Dibutyl tin dilaurate | 0.1 | part by weight |
| (trade name: L-101, dibutyl tin | | |
| dilaurate, manufactured by | | |
| Tokyo Fine Chemical CO., LTD.) | | |
| (4) Carbon black | 10.0 | parts by weight |
| (trade name: CB3050B, manufactured by | | |
| Mitsubishi Chemical Corporation) | | |
| (5) Calcium carbonate | 20.0 | parts by weight |
| (trade name: WHITON P-70, manufactured by | | |
| SHIRAISHI KOGYO KAISHA LTD.) | | |
| (6) HDI trimer | 10.7 | parts by weight |
| (polyisocyanate, trade name: N3500, | | |
| manufactured by Sumitomo Bayer | | |
| Urethane Co., Ltd.) | | |

In this case, the molar ratio (NCO/SH) of a thiol group of the polysulfide polymer and an NCO group of the HDI trimer is 1.05.

The above compositions (1) to (5) are mixed with a vacuum mixer and the composition (6) is further blended and added thereto, followed by casting in a mold which is provided around a SUS shaft (length: 330 mm, diameter: φ8 mm) preheated at 110° C. Curing is performed for 30 minutes at 110° C., the resultant is released from the mold, and after-cure is performed for 8 hours at 100° C. As a result. Conductive roller 1 in which an elastic layer is formed in the shaft is obtained.

### Example 2

Conductive roller 2 is obtained in the same preparation method as that of Example 1, except that the polysulfide polymer (1) is changed to “polysulfide polymer (trade name: THIOCOL LP-23, concentration of SH group: 2.0%, manufactured by Toray Fine Chemicals Co. Ltd.).

In this case, the molar ratio (NCO/SH) of a thiol group of the polysulfide polymer and an NCO group of the HDI trimer is 1.05.

### Example 3

Conductive roller 3 is obtained in the same preparation method as that of Example 1, except that the polysulfide polymer (1) is changed to “polysulfide polymer (trade name: THIOCOL LP-282, concentration of SH group: 2.1%, manufactured by Toray Fine Chemicals Co. Ltd.)” and the amount of the HDI trimer (6) is changed to 11.3 parts by weight.

In this case, the molar ratio (NCO/SH) of a thiol group of the polysulfide polymer and an NCO group of the HDI trimer is 1.05.

### Example 4

Conductive roller 4 is obtained in the same preparation method, as that of Example 1, except that the amount of the HDI trimer (6) is changed to 9.2 parts by weight.

In this case, the molar ratio (NCO/SH) of a thiol group of the polysulfide polymer and an NCO group of the HDI trimer is 0.90.

### Example 5

Conductive roller 5 is obtained in the same preparation method as that, of Example 1, except that the amount of the HDI trimer (6) is changed to 19.4 parts by weight.

In this case, the molar ratio (NCO/SH) of a thiol group of the polysulfide polymer and an NCO group of the HDI trimer is 1.90.

### Example 6

Conductive roller 6 is obtained in the same preparation method as that of Example 1, except that the HDI trimer (6) is changed to XDI (trade name: TAKENATE 500, manufactured by Mitsui Chemicals Inc.) and the mixing amount thereof is changed to 6.0 parts by weight.

In this case, the molar ratio (NCO/SH) of a thiol, group of the polysulfide polymer and an NCO group of the XDI is 1.05.

### Example 7

Conductive roller 7 is obtained in the same preparation method as that of Example 1, except, that the HDI trimer (6) is changed to 4,4′-MDI (trade name: COSMONATE PH, manufactured by Mitsui Chemicals Inc.) and the mixing amount thereof is changed to 8.0 parts by weight.

In this case, the molar ratio (NCO/SH) of a thiol, group of the polysulfide polymer and an NCO group of the 4,4′-MDI is 1.05.

### Example 8

Conductive roller 8 is obtained in the same preparation method as that, of Example 1, except that the amount of the HDI trimer (6) is changed to 5.1 parts by weight.

In this case, the molar ratio (NCO/SH) of a thiol group of the polysulfide polymer and an NCO group, of the HDI trimer is 0.6.

### Example 9

Conductive roller 9 is obtained in the same preparation method as that of Example 1, except that the amount of the HDI trimer (6) is changed to 21.4 parts by weight.

In this case, the molar ratio (NCO/SH) of a thiol group of the polysulfide polymer and an NCO group of the HDI trimer is 2.1.

### Comparative Example 1

| | | |
|---|---|---|
| (a) Polypropylene glycol | 100 | parts by weight |
| (trade name: Diol-3000, 37 mgKOH/g, | | |
| manufactured by Mitsui Chemicals Inc.) | | |
| (b) Ion conductive material | 0.5 | part by weight |
| (trade name: BTMAC-100, benzyl trimethyl | | |
| ammonium chloride, manufactured by | | |
| Lion Akzo Co., Ltd.) | | |
| (c) Dibutyl tin dilaurate | 0.1 | part by weight |
| (trade name: L-101, dibutyl tin dilaurate, | | |
| manufactured by Tokyo Fine Chemical | | |
| CO., LTD.) | | |
| (d) HDI trimer | 11.8 | parts by weight |
| (diisocyanate, trade name: N3500, | | |
| manufactured by Sumitomo Bayer | | |
| Urethane Co., Ltd.) | | |
| (e) Carbon black | 10.0 | parts by weight |
| (trade name: CB3050B, manufactured by | | |
| Mitsubishi Chemical Corporation) | | |
| (f) Calcium carbonate | 20.0 | parts by weight |
| (trade name: WHITON P-70, manufactured by | | |
| SHIRAISHI KOGYO KAISHA LTD.) | | |

The composition (a) is dehydrated at 110° C. for 4 hours under a reduced pressure of 3 Torr or less, the compositions (b), (c), (e), and (f) are further added and mixed with a vacuum mixer, and the composition (d) is further blended and mixed thereinto, followed by casting in a mold which is provided around a SUS shaft (length: 330 mm, diameter: φ8 mm) preheated at 110° C. Curing is performed for 30 minutes at 110° C., the resultant is released from the mold, and after-cure is performed for 8 hours at 100° C. As a result, Conductive roller C1 in which an elastic layer is formed in the shaft is formed.

### Comparative Example 2

### Preparation of Rubber Composition

A mixture of the following compositions is kneaded using a tangential type pressure kneader (manufactured by MORIYAMA COMPANY, actual capacity: 75 L) to prepare a rubber composition.

### Compositions

| | | |
|---|---|---|
| Elastic material | 100 | parts by weight |
| (epichlorohydrin-ethylene oxide-allyl | | |
| glycidyl ether copolymer rubber, trade | | |
| name: “GECHRON 3106”, manufactured | | |
| by ZEON CORPORATION) | | |
| Polysulfide polymer | 15 | parts by weight |
| (trade name: “THIOCOL LP-282”, manu- | | |
| factured by Toray Fine Chemicals Co. Ltd.) | | |
| Zinc oxide | 5 | parts by weight |
| (trade name: “ZINC OXIDE TYPE 2”, | | |
| manufactured by Seido Chemical | | |
| Industry Co., Ltd.) | | |
| Stearic acid | 1 | part by weight |
| (trade name: “STEARIC ACID S”, | | |
| manufactured by Kao Corporation) | | |
| Carbon black | 15 | parts by weight |
| (trade name: “KETJEN BLACK EC”, | | |
| manufactured by Lion Corporation) | | |
| Calcium carbonate | 20 | parts by weight |
| (trade name: “HAKUENKA CCR”, | | |
| manufactured by SHIRAISHI KOGYO | | |
| KAISHA LTD.) | | |
| Ion conductive material | 1 | part by weight |
| (alkyl trimethyl ammonium perchlorate, | | |
| trade name: “LXN-30”, manufactured | | |
| by DAISO CO., LTD.) | | |
| Vulcanizing agent | 1 | part by weight |
| (trade name: “SULFUR 200 MESH”, | | |
| manufactured by TSURUMI CHEMICAL | | |
| INDUSTRY CO., LTD.) | | |
| Vulcanizing accelerator | 2 | parts by weight |
| (trade name: “NOCCELER DM”, | | |
| manufactured by OUCHI SHINKO CHEMICAL | | |
| INDUSTRIAL CO., LTD.) | | |
| Vulcanizing accelerator | 0.5 | part by weight |
| (trade name: “NOCCELER TT”, | | |
| manufactured by OUCHI SHINKO CHEMICAL | | |
| INDUSTRIAL CO., LTD.) | | |

### Formation of Elastic Layer

As a core, a cylindrical core made of SUS 303 which has a diameter of 8 mm and a length of 330 mm is prepared. The rubber composition is casted using a cylindrical mold to form a 3 mm-thick unvulcanized rubber composition layer on this cylindrical core. Then, the temperature of the cylindrical mold is set to 170° C., followed by heating for 30 minutes. Then, the unvulcanized rubber composition layer is vulcanized and an elastic layer is formed.

### Formation of Surface Layer

A mixture of the following compositions is dispersed with a bead mill to prepare a dispersion. The obtained dispersion is diluted with methanol and thus a surface-layer-forming coating solution is obtained. Methanol and butanol are used to adjust the viscosity of the surface-layer-forming coating solution to be 45 Mpa·s. Then, the surface-layer-forming coating solution is poured into a dip coating bath.

Next, the core with the prepared elastic layer is dipped, in the coating solution in the dip coating bath and the core is pulled out. The core is dried at 150° C. for 10 minutes and a solvent is removed. As a result, a surface layer is formed. In this way, Conductive roller C2, which includes the elastic layer and the surface layer in this order on the core, is obtained.

### Compositions of Dispersion

| | | |
|---|---|---|
| Polymer | 100 | parts by weight |
| (amide resin, trade name: “ALAMINE | | |
| CM8000”, manufactured by TORAY | | |
| INDUSTRIES INC.) | | |
| Conductive material | 14 | parts by weight |
| (carbon black, trade name: “MONARCH | | |
| 1000”, manufactured by Cabot Corporation) | | |
| Solvent | 500 | parts by weight |
| (methanol, manufactured by KANTO | | |
| CHEMICAL CO., INC.) | | |
| Solvent | 240 | parts by weight |
| (butanol, manufactured by KANTO | | |
| CHEMICAL CO., INC.) | | |

### Resistance Test

### Ozone Resistance Test

Conductive rollers 1 to 9, C1, and C2 obtained above are left to stand for 200 hours in an environment of an ozone concentration of 5 ppm and a temperature of 35° C. and are left to stand for 24 hours in an environment of a temperature of 23° C. and a relative humidity of 50%. Then, the following image evaluation is conducted.

### Heat Resistance Test

Conductive rollers 1 to 9, C1, and C2 obtained above are left to stand in a drying machine at 90° C. for 168 hours and are left to stand for 24 hours in an environment of a temperature of 23° C. and a relative humidity of 50%. Then, the following image evaluation is conducted.

### Moisture Resistance Test

Conductive rollers 1 to 9, C1, and C2 obtained above are left, to stand for 168 hours in an environment of a temperature of 45° C. and a humidity of 95% and are left to stand for 24 hours in an environment of a temperature of 23° C. and a relative humidity of 50%. Then, the following image evaluation is conducted.

### Image Evaluation

After the above-described resistance tests are conducted, the respective Conductive rollers 1 to 9, C1, and C2 are held in contact with a photoreceptor of a color copying machine DocuCentre Color 400CP (manufactured by Fuji Xerox Co. Ltd.) for 14 days in an environment of 28° C. and 85% RH.

Next, Conductive rollers 1 to 9, C1, and C2 are mounted to the color copying machine DocuCentre Color 400CR (manufactured by Fuji Xerox Co. Ltd.) as a photoreceptor charging roller. Then, using color toners (cyan, magenta, yellow, and black) for the color copying machine DocuCentre Color 400CP, a printing test is conducted with respect, to 50,000 A4-sized images (25,000 images are printed in an environment, of 10° C. and 15% RH and 25,000 images are printed in an environment of 28° C. and 85% RH). In this case, when there is a significant problem halfway, printing is stopped immediately.

The image evaluation for the initial images and images printed after 50,000 images being printed is conducted according to the following criteria with a method in which whether or not there is unevenness in the densities of the halftone images is determined by visual inspection.

A: Defects such as unevenness in density are not found
B: Unevenness in density occurs to a very small degree
C: Unevenness in density occurs to a small degree
D: Unevenness in density occurs to a degree that is not allowable in practice.

TABLE 1

| | | | | | | | | | | | Comparative | |
|---|---|---|---|---|---|---|---|---|---|---|---|---|
| | | Examples | | | | | | | | | Examples | |
| | | 1 | 2 | 3 | 4 | 5 | 6 | 7 | 8 | 9 | 1 | 2 |
| Conductive Roller | | 1 | 2 | 3 | 4 | 5 | 6 | 7 | 8 | 9 | C1 | C2 |
| Ozone | Initial | A | A | A | A | A | A | A | B | B | D | B |
| Resistance | Stage | | | | | | | | | | | |
| | After | A | A | A | B | B | A | A | C | C | Not | D |
| | Printing | | | | | | | | | | Evaluated | |
| Heat | Initial | A | A | A | A | A | A | A | B | B | D | B |
| Resistance | Stage | | | | | | | | | | | |
| | After | A | A | A | B | B | A | A | C | C | Not | D |
| | Printing | | | | | | | | | | Evaluated | |
| Moisture | Initial | A | A | A | A | A | A | A | B | B | C | B |
| Resistance | Stage | | | | | | | | | | | |
| | After | A | A | A | B | B | A | A | C | C | D | D |
| | Printing | | | | | | | | | | | |

As shown in Table 1, in the Examples, when the image evaluation is conducted using Conductive Rollers 1 to 9 which include an elastic layer containing a rubber composition in which a thiourethane bond is formed, the occurrence of unevenness in the densities of the images is suppressed in all the tests of ozone resistance, heat resistance, and moisture resistance.

On the other hand, in the Comparative Example 1 using Conductive roller C1 which includes an elastic layer containing a rubber composition in which polypropylene glycol is used for the preparation and a thiourethane bond is not formed, unevenness in density occurs. Furthermore, in the Comparative Example 2 using Conductive roller C2 which includes an elastic layer containing a rubber composition in which a polysulfide polymer not having a thiourethane bond is used for the preparation, unevenness in density occurs after printing. It is considered that, this unevenness in density occurs because a photoreceptor is contaminated by the occurrence of bleeding in a high-ozone environment, a high-temperature environment, and a high-humidity environment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A roll member comprising:
a core; and
an elastic layer which contains a rubber composition having a thiourethane bond represented by Formula (1) on the core:
—(S—C(═O)—N(—H))—. Formula (1)

2. The roll member according to claim 1,
wherein the rubber composition is formed of a polysulfide polymer (A) and a compound (B), and
the polysulfide polymer (A) contains a structural unit of “—S—” and at least one structural unit selected from “(C₂H₄OCH₂OC₂H₄)—” and “—(CH₂CH(OH)CH₂)—” and has a thiol group (—SH) in a terminal thereof; and
the compound (B) has at least two or more isocyanate groups (—N═C═O).

3. The roll member according to claim 2,
wherein the polysulfide polymer (A) contains a structural unit, represented by “—(CH₂CH(OH)CH₂)—”.

4. The roll member according to claim 2,
wherein a concentration of the thiol group (—SH) in the polysulfide polymer is from 1.0% by weight to 6.0% by weight with respect to 100 parts by weight of the polysulfide polymer.

5. The roll member according to claim 2,
wherein the polysulfide polymer has a polyether unit represented by —(R¹O)ₙ—, wherein, R¹ represents an alkylene group having from 2 to 4 carbon atoms and n represents an integer of from 6 to 200.

6. The roll member according to claim 1,
wherein a thickness of the elastic layer is from 1 mm to 10 mm.

7. The roll member according to claim 1,
wherein a volume resistivity of the elastic layer is from 10⁴ Ωcm to 10¹⁰ Ωcm.

8. A charging device comprising:
the roll member according to claim 1.

9. The charging device according to claim 8,
wherein the elastic layer of the roll member includes a rubber composition formed of a polysulfide polymer (A) and a compound (B), and
the polysulfide polymer (A) contains a structural unit of “—S—” and at least one structural unit selected from “—(C₂H₄OCH₂OC₂H₄)—” and “—(CH₂CH(OH)CH₂)—” and has a thiol group (—SH) in a terminal thereof; and
the compound (B) has at least two or more isocyanate groups (—N═C═O).

10. The charging device according to claim 8,
wherein a thickness of the elastic layer of the roll member is from 1 mm to 10 mm.

11. The charging device according to claim 8,
wherein a volume resistivity of the elastic layer of the roll member is from 10⁴ Ωcm to 10¹⁰ Ωcm.

12. An image forming apparatus comprising:
an image holding member;
a charging device that, charges a surface of the image holding member;
a latent image forming device that, forms an electrostatic latent image on a charged surface of the image holding member;
a developing device that develops the electrostatic latent image, formed on the image holding member, using toner to form a toner image; and
a transfer device that, transfers the toner image, formed on the image holding member, onto a recording medium,
wherein the charging device is the charging device according to claim 8.

13. The image forming apparatus according to claim 12,
wherein the elastic layer of the roll member of the charging device includes a rubber composition formed of a polysulfide polymer (A) and a compound (B), and
the polysulfide polymer (A) contains a structural unit of “—S—” and at least one structural unit, selected from “—(C₂H₄OCH₂OC₂H₄)—” and “—(CH₂CH(OH)CH₂)—” and has a thiol group (—SH) in a terminal thereof; and
the compound (B) has at least two or more isocyanate groups (—N═C═O).

14. The image forming apparatus according to claim 12,
wherein a thickness of the elastic layer of the roll member of the charging device is from 1 mm to 10 mm.

15. The image forming apparatus according to claim 12,
wherein a volume resistivity of the elastic layer of the roll member of the charging device is from 10⁴ Ωcm to 10¹⁰ Ωcm.

16. A process cartridge comprising:
a charging device that charges an image holding member; and
at least one kind selected from the image holding member, a developing device that develops an electrostatic latent image on the image holding member, using toner to form a toner image, and a cleaning device that cleans and removes toner remaining on a surface of the image holding member after the toner image is transferred onto a recording medium,
wherein the charging device is the charging device according to claim 8.

17. The process cartridge according to claim 16,
wherein the elastic layer of the roll member of the charging device includes a rubber composition formed of a polysulfide polymer (A) and a compound (B), and
the polysulfide polymer (A) contains a structural unit of “—S—” and at least one structural unit selected from “—(C₂H₄OCH₂OC₂H₄)—” and “—(CH₂CH(OH)CH₂)—” and has a thiol group (—SH) in a terminal thereof; and
the compound (B) has at least two or more isocyanate groups (—N═C═O).

18. The process cartridge according to claim 16,
wherein a thickness of the elastic layer of the roll member of the charging device is from 1 mm to 10 mm.

19. The process cartridge according to claim 16,
wherein a volume resistivity of the elastic layer of the roll member of the charging device is from 10⁴ Ωcm to 10¹⁰ Ωcm.
